(19) United States
(12) Patent Application Publication
(10) Pub. No.: US 2026/0124584 A1
(43) Pub. Date: May 7, 2026

(54) NANO SILK FIBROIN FIBROUS MEMBRANE WITH DIRECTIONAL WATER TRANSPORT AND PREPARATION METHOD THEREOF

(71) Applicants: NANJING UNIVERSITY, Nanjing City (CN); HAIAN INSTITUTE OF HIGH-TECH RESEARCH, NANJING UNIVERSITY, Nantong City (CN)

(72) Inventors: Shaochun TANG, Nanjing City (CN); Jiajun HE, Nanjing City (CN); Chao CHEN, Nantong City (CN)

(21) Appl. No.: 19/379,782

(22) Filed: Nov. 5, 2025

(30) Foreign Application Priority Data
Nov. 7, 2024 (CN) 202411581511.7

(51) Int. Cl. B01D 67/00; B01D 71/74

(52) U.S. Cl. CPC B01D 67/0002; B01D 67/0088; B01D 67/0093; B01D 71/74; B01D 2323/39

(57) ABSTRACT

A nano silk fibroin fibrous membrane with directional water transport and a preparation method thereof are provided. Firstly, renewable pure silk fibroin is extracted from natural silkworm cocoons. A silk fibroin film with a nanofibrous structure is prepared by an electrostatic spinning method, and a methanol treatment method is used to induce a secondary structure transformation of the silk fibroin film. Then, a spraying process is used to spray octadecyltrichlorosilane (OTS) onto the silk fibroin fibrous membrane, and a uniformly and regularly arranged mesh hydrophobic inner layer and mesh water transport channels are deposited on one side.

### CROSS-REFERENCE TO RELATED APPLICATIONS

This application claims priority to Chinese Patent Application No. 202411581511.7, filed on Nov. 7, 2024, the contents of which are hereby incorporated by reference.

### TECHNICAL FIELD

The present disclosure relates to the technical field of fibrous membranes, and in particular to a nano silk fibroin fibrous membrane with directional water transport and a preparation method thereof.

### BACKGROUND

With technological development, functional textiles and wearable materials are becoming hot research topics for improving human physiological comfort without consuming extra energy to manage the entire environmental temperature.

Functional textiles or wearable materials are generally made from fibrous membranes. The water transport properties of the fibrous membrane greatly affect human physiological comfort. Water transport in traditional fibrous membranes is bidirectional, leading to undesired wet stickiness. Therefore, there is an urgent need to develop new fibrous membranes with directional water transport to achieve more effective moisture management and heat management.

### SUMMARY

The embodiments of the present disclosure provide a nano silk fibroin fibrous membrane with directional water transport and a preparation method thereof. The silk fibroin membrane prepared by the electrostatic spinning method and subjected to secondary structure treatment possesses hydrophilic, moisture-absorbing, and radiative cooling properties. Then, octadecyltrichlorosilane (OTS) is sprayed on a single layer of this silk fibroin fibrous membrane to form mesh water transport channels and a hydrophobic coating, thereby achieving the function of directional water transport while maintaining the original mechanical properties of the silk fibroin fibrous membrane. Moreover, the preparation method is environmentally friendly, simple, and scalable.

An embodiment of the present disclosure provides a nano silk fibroin fibrous membrane with directional water transport, where the nano silk fibroin fibrous membrane is prepared by an electrostatic spinning method, a uniformly and regularly arranged mesh hydrophobic coating is deposited on a single layer surface, and mesh hydrophilic channels are formed on the single layer surface.

In an embodiment, the mesh hydrophobic coating is OTS, with a coating area of 55%-65%, specifically a 60% hydrophobic coating.

An embodiment of the present disclosure further provides a preparation method for a nano silk fibroin fibrous membrane with directional water transport, specifically including the following steps:
S1, preparation of a hydrophilic silk fibroin fibrous membrane;
firstly, extracting renewable pure silk fibroin from natural silkworm cocoons, preparing a silk fibroin film with a nanofibrous structure by an electrostatic spinning method, and inducing a secondary structure transformation of the silk fibroin film using a methanol treatment method to obtain a hydrophilic and moisture-absorbent silk fibroin fibrous membrane;
S2, preparation of a mesh hydrophobic inner layer;
dissolving OTS in n-hexane for later use, where a volume ratio of the OTS to the n-hexane is 1:20;
covering a surface of the nano silk fibroin fibrous membrane obtained in the S1 with a mesh glass fiber as a mask, where a pore density of the glass fiber mask is 55%-65%, and using a spraying method to deposit a uniform layer of OTS as a hydrophobic coating on one side of the nano silk fibroin fibrous membrane; and
after an OTS solution volatilizes and dries, removing the mask, forming mesh hydrophilic channels on the surface of the nano silk fibroin fibrous membrane. Thus, a silk fibroin fibrous membrane with specific directional water transport is prepared.

One or more technical solutions provided in the embodiments of the present disclosure have at least the following technical effects or advantages.

The present disclosure prepares a silk fibroin film with a nanofibrous structure by an electrostatic spinning method and induces the secondary structure transformation of the silk fibroin film using a methanol treatment method, enabling the silk fibroin film to achieve hydrophilic and moisture-absorbing properties, radiative cooling properties, and mechanical strength properties. Then, a spraying process is used to spray OTS onto the silk fibroin fibrous membrane, and a uniformly and regularly arranged mesh hydrophobic inner layer and mesh water transport channels are deposited on one side. The prepared silk fibroin fibrous membrane bearing the OTS coating possesses the function of directional water transport, with a directional water transport index R as high as 978%, while retaining the original radiative cooling properties and mechanical strength properties of the silk fibroin fibrous membrane, capable of meeting the durability characteristics such as mechanical strength required in practical applications.

The preparation method provided by the present disclosure has a simple process, mild reaction conditions, easy post-treatment processes, is easy to control, and suitable for large-scale production.

Using a self-made silk fibroin fibrous membrane as the base membrane to prepare the fibrous membrane with directional water transport, the silk fibroin fibrous membrane does not contain any inorganic particles added to improve reflectivity, resulting in high safety and comfort for the human body.

The spaced arrangement of the OTS hydrophobic coating in the present disclosure forms mesh water transport channels on the single layer surface of the silk fibroin fibrous membrane, which may effectively conduct sweat secreted by the skin.

### BRIEF DESCRIPTION OF THE DRAWINGS

FIG. 1 is a schematic structural diagram of a nano silk fibroin fibrous membrane with directional water transport according to the present disclosure.

FIG. 2 is a schematic diagram of directional water transport of the nano silk fibroin fibrous membrane with directional water transport according to the present disclosure.

FIG. 3 is a spectrum of the nano silk fibroin fibrous membrane according to the present disclosure in a 0.3 micrometer (μm)-15 μm band.

FIG. 4 is a test result graph of one-way transport index R values for 55% silk fibroin fibrous membrane, 60% silk fibroin fibrous membrane, and 65% silk fibroin fibrous membrane according to the present disclosure.

FIG. 5 is a flowchart of a preparation method for a nano silk fibroin fibrous membrane with directional water transport.

### DETAILED DESCRIPTION OF THE EMBODIMENTS

The embodiments of the present disclosure provide a nano silk fibroin fibrous membrane with directional water transport and a preparation method thereof. The silk fibroin membrane prepared by the electrostatic spinning method and subjected to secondary structure treatment possesses hydrophilic, moisture-absorbing, and radiative cooling properties. Then, octadecyltrichlorosilane (OTS) is sprayed on a single layer of this silk fibroin fibrous membrane to form mesh water transport channels, thereby achieving the function of directional water transport while maintaining the original mechanical properties of the silk fibroin fibrous membrane. Moreover, the preparation method is environmentally friendly, simple, and scalable.

To solve the above problems, the overall technical solution in the embodiments of the present disclosure is as follows.

Firstly, renewable pure silk fibroin is extracted from natural silkworm cocoons, a silk fibroin film with a nanofibrous structure is prepared by an electrostatic spinning method, and a secondary structure transformation of the silk fibroin film is induced using a methanol treatment method, enabling the silk fibroin film to achieve hydrophilic and moisture-absorbing properties. Then, a spraying process is used to spray OTS onto the silk fibroin fibrous membrane, a uniformly and regularly arranged mesh hydrophobic inner layer is deposited on one side. The prepared silk fibroin fibrous membrane bearing the OTS coating possesses relatively good directional water transport function, with a directional water transport index R as high as 978%.

To better understand the above technical solution, a detailed explanation of the above technical solution will be provided below in conjunction with the accompanying drawings in the specification and specific implementation methods.

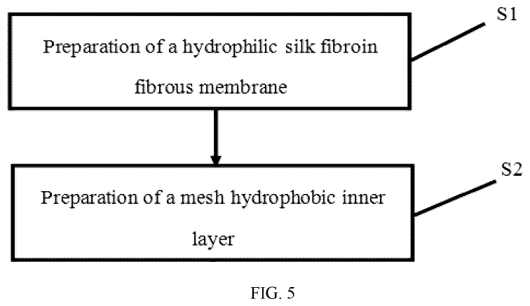

A preparation method for a nano silk fibroin fibrous membrane with directional water transport, as shown in FIG. 5, including following specific steps: S1, preparation of a hydrophilic silk fibroin fibrous membrane; and S2, preparation of a mesh hydrophobic inner.

### Embodiment 1

### (1) Preparation of the Hydrophilic Silk Fibroin Fibrous Membrane

### \textcircled{1} Preparation of Silk

Ten grams (g) of natural silkworm cocoons are cut into pieces, the cut natural silkworm cocoons are placed into a Na₂CO₃ solution with a concentration of 0.5 weight percent (wt %), heating to 100 degrees Celsius (° C.) for degumming treatment, with a bath ratio of 70:1, and the degumming time is controlled to 40 minutes (min)-45 min; the degummed natural silk is repeatedly washed with distilled water, and dried in an oven at 60° C. to obtain degummed silk.

### \textcircled{2} Preparation of Pure Silk Fibroin

The obtained degummed silk is dissolved in a formic acid (FA)/CaCl₂) solution, where the CaCl₂) content is 5 wt %, and the degummed silk accounts for 5 wt % of the total mixed solution. Then, the mixed solution is poured into a culture dish and dried into a film. The obtained film is placed in distilled water for immersion treatment for 2 days, and dried in an oven at 60° C. to obtain pure silk fibroin (SF).

### \textcircled{3} Preparation of the Nano Silk Fibroin Fibrous Membrane

The pure silk fibroin from the step \textcircled{2} is dissolved in an FA solution to obtain a silk fibroin/formic acid (SF/FA) electrostatic spinning solution with a silk fibroin (SF) content of 15 wt %.

The electrostatic spinning voltage is 20 kilovolt (kV), the spinning distance is 12 centimeters (cm), the feed rate is 2 milliliters per hour (mL/h), the rotating speed of the drum is 110 revolutions per minute (rpm), the ambient temperature is 25° C., and the spinning time is 24 hours (h) to prepare the spun membrane. The spun membrane is immersed in a methanol solution for 10 min after being removed to obtain the nano silk fibroin fibrous membrane.

### (2) Preparation of the Mesh Hydrophobic Inner Layer

The OTS is dissolved in n-hexane for later use, with a volume ratio of OTS to n-hexane of 1:20.

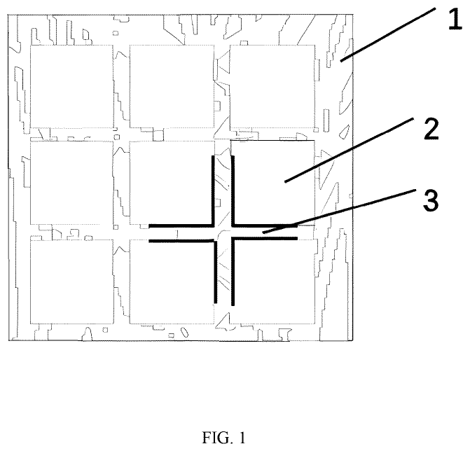

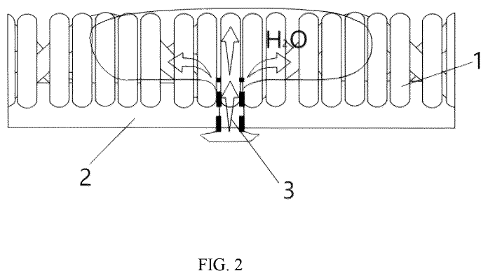

FIG. 1 is a schematic structural diagram of a nano silk fibroin fibrous membrane with directional water transport according to the present disclosure. FIG. 2 is a schematic diagram of directional water transport of the nano silk fibroin fibrous membrane with directional water transport according to the present disclosure. The surface of the nano silk fibroin fibrous membrane is covered with a mesh glass fiber as a mask, where the pore density of the glass fiber mask is 55%, and a spraying method is used to deposit a uniform layer of OTS as a hydrophobic coating 2 on one side of the nano silk fibroin fibrous membrane 1. After the OTS solution volatilizes and dries, the mask is removed, that is mesh hydrophilic channels 3 are formed on the surface of the nano silk fibroin fibrous membrane, and the silk fibroin fibrous membrane with specific directional water transport is prepared. The obtained silk fibroin fibrous membrane has a hydrophobic coating area of 55%.

### Embodiment 2

The pore density of the glass fiber mask in Embodiment 1 is changed to 60%, with other conditions the same as in Embodiment 1, to obtain a silk fibroin fibrous membrane with a hydrophobic coating area of 60%.

### Embodiment 3

The pore density of the glass fiber mask in Embodiment 1 is changed to 65%, with other conditions the same as in Embodiment 1, to obtain a silk fibroin fibrous membrane with a hydrophobic coating area of 65%.

### Infrared Performance Test of the Nano Silk Fibroin Fibrous Membrane Product

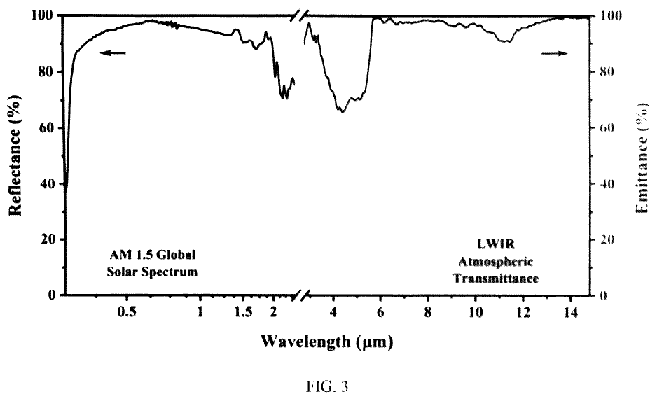

With reference to FIG. 3, the spectrum of the nano silk fibroin fibrous membrane in the 0.3 micrometer (μm)-15 μm band is shown. The nano silk fibroin fibrous membrane has an average reflectivity of 95% in the 0.3-2.5 μm band of sunlight and an average reflectivity of 95% in the 8-13 μm “atmospheric transparent window”, exhibiting excellent passive cooling characteristics.

### Test of the One-Way Transport Index R Values for the 55% Silk Fibroin Fibrous Membrane, 60% Silk Fibroin Fibrous Membrane, and 65% Silk Fibroin Fibrous Membrane

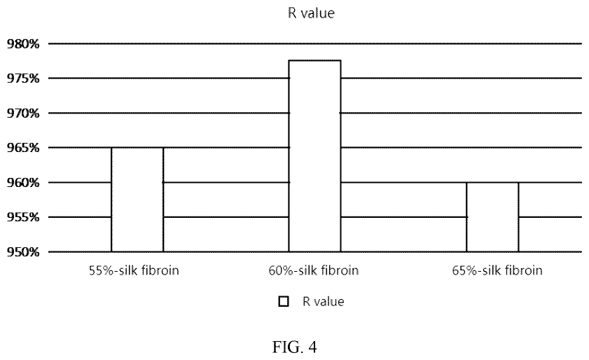

With reference to FIG. 4, the R values for the 55% silk fibroin fibrous membrane, 60% silk fibroin fibrous membrane, and 65% silk fibroin fibrous membrane are 965%, 978%, and 960%, respectively. The R values are all above 600%, showing good unidirectional water transport capability. This is because the mesh hydrophilic channels play a drainage role, rapidly transferring liquid to the hydrophilic layer, which also indicates that the presence of mesh hydrophilic channels is more beneficial for achieving ultrafast unidirectional water transport.

### Test of the Cooling Capacity of the 55% Silk Fibroin Fibrous Membrane, 60% Silk Fibroin Fibrous Membrane, and 65% Silk Fibroin Fibrous Membrane

The 55% silk fibroin fibrous membrane, 60% silk fibroin fibrous membrane, and 65% silk fibroin fibrous membrane are subjected to indoor simulation under one sun illumination, and an infrared thermal camera is used to record the real-time temperature of the silk fibroin fibrous membranes with different hydrophobic areas.

The specific operation is that under stable and continuous sunlight irradiation, the fibrous membrane rapidly heats up. When the fibrous membrane maintains stable fluctuations under continuous sunlight irradiation, 0.1 milliliter (mL) of water is added to the bottom of the fibrous membrane. The evaporation and drying process of the moist fibrous membrane is analyzed, and the results are as follows: the drying times for the 55% silk fibroin fibrous membrane, 60% silk fibroin fibrous membrane, and 65% silk fibroin fibrous membrane are 7.5 min, 6.5 min, and 8 min, respectively. The 60% silk fibroin fibrous membrane may quickly transport moisture to the upper layer, has the shortest drying time, and exhibits an excellent water evaporation rate. The results are shown in Table 1.

TABLE 1
Test results of cooling capacity of 55% silk fibroin
fibrous membrane, 60% silk fibroin fibrous membrane,
and 65% silk fibroin fibrous membrane

| | 55% silk | 60% silk | 65% silk |
|---|---|---|---|
| | fibroin | fibroin | fibroin |
| | fibrous | fibrous | fibrous |
| Time | membrane | membrane | membrane |

| | | | | |
|---|---|---|---|---|
| 0 | min | 28.2 | 28.1 | 28.2 |
| 1-3 | min | 35.2 | 33.1 | 35.6 |

| | | | |
|---|---|---|---|
| 3.5 min (Start adding | 28.9 | 26.7 | 29 |
| 0.1 mL water) | | | |

| | | | | |
|---|---|---|---|---|
| 4-9.5 | min | 29.0 | 25.8 | 29.3 |
| 9.8 | min | 29.4 | 26.5 | 28.3 |
| 10 | min | 29.0 | 32.8 | 29.0 |
| 10.5 | min | 29.3 | 33.2 | 28.2 |
| 11 | min | 34.8 | 33.1 | 29.3 |
| 11.5 | min | 34.9 | 32.6 | 35 |
| 12-14 | min | 35.1 | 25.5 | 35.5 |

Furthermore, the 60% silk fibroin fibrous membrane and the nano silk fibroin fibrous membrane obtained in the step \textcircled{3} are placed on a 37° C. hot plate to simulate covering the human body surface. The top is irradiated with simulated sunlight AM 1.5G under 1 sun (100 milliwatt per square centimeter (mW/cm²)), and the bottom temperature of the fibrous membrane is recorded by a thermocouple. At 5 min, 0.1 mL of water is dripped onto the bottom of the fibrous membrane. At the moment of dripping water, the temperature of the fibrous membrane decreases rapidly. After 6.5 min, the temperature of the 60% silk fibroin fibrous membrane rapidly increases and reaches the temperature before water dripping, indicating that the moisture in the fibrous membrane has completely evaporated at this time. The nano silk fibroin fibrous membrane obtained in the step \textcircled{3} starts to decrease in temperature 2 min after water dripping, and only begins to heat up at the 15th min, taking 13 min to completely evaporate the moisture.

The test results prove that the 60% silk fibroin fibrous membrane has faster moisture transfer and evaporation capabilities than the nano silk fibroin fibrous membrane obtained in the step \textcircled{3}.

In summary, the nano silk fibroin fibrous membrane with directional water transport possesses both radiative cooling function and directional water transport function. The preparation method of the technical solution of the present disclosure has a simple process, mild reaction conditions, easy post-treatment processes, is easy to control, and may be applied to large-scale production. The prepared silk fibroin fibrous membrane with directional water transport may meet the durability characteristics such as mechanical strength required in practical applications, and has good human body safety and comfort, and may be used for preparing textiles, especially functional fabrics and wearable materials.

Although preferred embodiments of the present disclosure have been described, one of ordinary skill in the art, once aware of the basic creative concepts, may make additional changes and modifications to these embodiments. Therefore, the appended claims are intended to be interpreted as including the preferred embodiments and all alterations and modifications falling within the scope of the present disclosure.

Apparently, those ordinary skill in the art may make various changes and modifications to the present disclosure without departing from the spirit and scope of the present disclosure. Thus, if these modifications and variations of the present disclosure fall within the scope of the claims of the present disclosure and their equivalent technologies, the present disclosure also intends to cover these changes and modifications.

What is claimed is:

1. A preparation method for a nano silk fibroin fibrous membrane with directional water transport, comprising following specific steps:
S1, preparation of a hydrophilic silk fibroin fibrous membrane;
firstly, extracting renewable pure silk fibroin from natural silkworm cocoons, preparing a silk fibroin film with a nanofibrous structure by an electrostatic spinning method, and inducing a secondary structure transformation of the silk fibroin film using a methanol treatment method to obtain a hydrophilic and moisture-absorbent silk fibroin fibrous membrane;
S2, preparation of a mesh hydrophobic inner layer;
dissolving octadecyltrichlorosilane in n-hexane for a later use, wherein a volume ratio of the octadecyltrichlorosilane to the n-hexane is 1:20;
covering a surface of the nano silk fibroin fibrous membrane obtained in the S1 with a mesh glass fiber as a mask, and using a spraying method to deposit a uniform layer of the octadecyltrichlorosilane as a hydrophobic coating on one side of the nano silk fibroin fibrous membrane; and
after an octadecyltrichlorosilane solution volatilizes and dries, removing the mask, forming mesh hydrophilic channels on the surface of the nano silk fibroin fibrous membrane.

2. The preparation method for the nano silk fibroin fibrous membrane with directional water transport according to claim 1, wherein a pore density of the glass fiber in the S2 step is 55%-65%.

3. A nano silk fibroin fibrous membrane with directional water transport, prepared by the preparation method according to claim 1.

4. The nano silk fibroin fibrous membrane with directional water transport according to claim 3, wherein the nano silk fibroin fibrous membrane with directional water transport is used for preparing textiles.

5. The nano silk fibroin fibrous membrane with directional water transport according to claim 4, wherein the nano silk fibroin fibrous membrane with directional water transport is used for preparation of functional fabrics and wearable textiles.
